(19) United States
(12) Patent Application Publication
(10) Pub. No.: US 2011/0278267 A1
(43) Pub. Date: Nov. 17, 2011

(54) SCRIBING APPARATUS AND SCRIBING METHOD

(75) Inventor: Hiroshi Kawakami, Ashigarakami-gun (JP)

(73) Assignee: FUJIFILM CORPORATION, Minato-ku, Tokyo (JP)

(21) Appl. No.: 13/145,048

(22) PCT Filed: Jan. 12, 2010
(86) PCT No.: PCT/JP2010/050457

§ 371 Date: Jul. 18, 2011

(30) Foreign Application Priority Data
Jan. 16, 2009 (JP) 2009-007136

(51) Int. Cl. B23K 26/00

(52) U.S. Cl. 219/121.67; 83/880

(57) ABSTRACT

Performing scribing accurately with a high yield rate. A scribing apparatus (1), including a conveyance means (10) for conveying a web of strip-like continuous flexible substrate (B) on which a target scribing film (M) is formed by applying a tensile strength, a pressing means (20) for pressing the flexible substrate (B) by bringing a convex curved surface (21S) into contact with the flexible substrate (B) from a side on which the target subscribing film (M) is not formed, and a scribing means (30) for performing scribing on the target scribing film (M) in which a tensile strength Tn and a pressing force P applied to the flexible substrate per unit cross-sectional area during the scribing satisfy Formulae (1) to (3) below:

1.5 MPa≦Tn≦25 MPa (1)

4 kPa≦P≦50 kPa (2)

5 GPa²≦Tn×P≦800 GPa² (3)

### TECHNICAL FIELD

The present invention relates to a scribing apparatus and a scribing method for performing scribing on a strip-like continuous flexible film on which a scribing target film is formed.

### BACKGROUND ART

Photoelectric conversion devices having a photoelectric conversion layer that generates a current by absorbing light and electrodes for drawing out the current generated in the photoelectric conversion layer are used in various applications, such as solar cells and the like. Most of the conventional solar cells are Si cells using bulk monocrystalline Si, polycrystalline Si, or thin film amorphous Si. Recently, however, research and development of compound semiconductor solar cells that do not depend on Si has been carried out. As compound semiconductor solar cells, two types are known, one of which is a bulk system, such as GaAs system and the like, and the other of which is a thin film system, such as CIS (Cu—In—Se) system formed of a group Ib element, a group IIIb element, and a group VIb element, CIGS (Cu—In—Ga—Se), or the like. CIS systems or CIGS systems has high light absorption rates and high energy conversion efficiency is reported.

In various fields of electronic devices including thin film photoelectric conversion devices, development of technologies for forming and processing various functional films on a flexible substrate, thereby laminating an entire device into a sheet has been conducted. Such a process may reduce the amount of material used and allows continuous processing (roll-to-roll processing) so that the manufacturing costs may be reduced. Flexible substrates for photoelectric conversion devices may include a substrate having a metal base on which an insulation film is formed, and the like.

Heretofore, integrated devices are monolithically fabricated for high efficiency and low cost. One of the key technologies for that purpose is to divide a film into many cells by providing separation grooves in the film.

For example, as shown in FIGS. 5A and 5B, Thin film photoelectric conversion device 100 has first separation grooves 161 that run through only lower electrode 120, second separation grooves 162 that run through photoelectric conversion layer 130 and buffer layer 140, and third separation grooves 163 that run through only upper electrode layer 150 in a lateral sectional view and fourth separation grooves 164 that run through photoelectric conversion layer 130, buffer layer 140, and upper electrode layer 150 in a longitudinal sectional view.

In the photoelectric conversion device described above, scribing appropriate for the material and property of each film is performed. For a CIGS device, for example, it is customary that first separation grooves 161 are formed by laser scribing while second to fourth separation grooves 162 to 164 are formed by mechanical scribing using a scriber blade.

When scribing a target film formed on a flexible substrate by roll-to-roll processing, it is necessary to perform the scribing while preventing warpage, undulation, deflection, and the like of the flexible film in order to accurately and efficiently perform the scribing.

Japanese Unexamined Patent Publication No. 10 (1998)-027918 discloses an apparatus in which, while conveying a web of flexible substrate on which a target scribing film is formed, laser scribing is performed with the flexible substrate being brought into contact with and pressed by a roller-like substrate support means (claim 2, FIG. 1, and the like).

Japanese Unexamined Patent Publication No. 2001-044471 discloses an apparatus in which, while conveying a web of flexible substrate on which a target scribing film is formed, laser scribing is performed with the flexible substrate being held by a flat plate like substrate position keeping means (claim 3, FIG. 3, and the like).

Japanese Unexamined Patent Publication No. 2004-146773 discloses, as a conventional technology, an apparatus in which, while conveying a web of flexible substrate on which a target scribing film is formed, mechanical scribing using a scriber blade is performed with the flexible substrate being held by two guide rolls (claim 3, FIG. 3, and the like). Japanese Unexamined Patent Publication No. 2004-146773 also proposes the use of micro plasma dry etching for separation groove formation (claim 1, FIG. 1, and the like).

When performing scribing on a target film formed on a flexible substrate by roll-to-roll processing, it is necessary to highly accurately form a separation groove at a speed faster than that of sheet-to-sheet processing. For example, in a photoelectric conversion device, if a first separation groove that runs through the lower electrode is not clearly formed and a residue of the electrode which should have been removed remains, a short circuit occurs between the electrode and an electrode of an adjacent cell, whereby leakage current flows and desired photoelectrical conversion efficiency can not be obtained. Otherwise, if the lower electrode is cut too deeply and an insulation film on the substrate is also cut, a dielectric breakdown occurs, resulting in a short circuit between the lower electrode and metal base.

Japanese Unexamined Patent Publication Nos. 10 (1998)-027918, 2001-044471, and 2004-146773, however, do not describe specific conditions at all, such as the tensile strength, pressing force, and the like to be applied to the flexible substrate, so that specific conditions for stably forming an accurate separation groove in a thin film are not clear.

If the tensile strength or pressing force is too small, it is difficult to prevent warpage, undulation, and deflection of a flexible substrate, whereby the positioning and cutting depth control of the scribing become difficult. On the other hand, if the tensile strength or pressing force is too large, an excessive stress is applied to the flexible substrate, causing small abrasions and cracks around a separation groove or invisible damages.

The present invention has been developed in view of the circumstances described above, and it is an object of the present invention to provide a scribing apparatus and a scribing method capable of, while conveying a substrate web, performing efficient and accurate scribing on a target scribing film with a high yield rate and stably.

### DISCLOSURE OF INVENTION

A scribing apparatus of the present invention is an apparatus, including:

a conveyance means for conveying a web of strip-like continuous flexible substrate on which a target scribing film is formed by applying a tensile strength to the flexible substrate;

a pressing means, having a convex curved surface, for pressing the flexible substrate by bringing the convex curved surface into contact with the flexible substrate from a side on which the target subscribing film is not formed; and

a scribing means for performing scribing on the target scribing film formed on the surface of a portion of the flexible substrate pressed by the pressing means,

wherein a tensile strength Tn and a pressing force P applied to the flexible substrate per unit cross-sectional area during the scribing satisfy Formulae (1) to (3) below:

1.5 MPa≦Tn≦25 MPa (1)

4 kPa≦P≦50 kPa (2)

5 GPa²≦Tn×P≦800 GPa² (3)

The tensile strength Tn and pressing force P are parameters represented by the following formulae:

Tn=T/S_{S}(Pa),P=T/(W×R)(Pa)

(where, T represents the tensile strength applied the entire cross-section of the flexible substrate, S_{S} represents the cross-sectional area of the flexible substrate, W represents the width of the flexible substrate, and R represents the radius of curvature of the convex curved surface.)

In the scribing apparatus of the present invention, the flexible substrate may be conveyed by continuous conveyance or intermittent conveyance. In the case of the intermittent conveyance, the scribing may be performed when the substrate is in conveyance or stopped. There is not any specific restriction on the flexible substrate and a metal substrate, a substrate of metal base on which an insulation film is formed, a resin substrate, and the like may be cited. The flexible substrate may include any one or more types of films, such as an insulation film, an electrode, and the like, between the surface of the substrate and the target scribing film. In this case, the cross-sectional area of the flexible substrate is defined as the cross-sectional area including the layer or layers formed under the target scribing film. The target scribing film may be a single layer film or a laminated film.

In the scribing apparatus of the present invention, it is preferable that the conveyance means includes a first roller for paying out the flexible substrate and a second roller for rolling up the flexible substrate after subjected to the scribing, and the pressing means includes a pressing roller for pressing the flexible substrate. In such a configuration, it is preferable that the pressing roller has a radius of 40 to 300 mm. In the scribing apparatus of the present invention, it is preferable that the position of the convex curved surface is changeable with respect to the flexible substrate.

As for the scribing means, a scribing means that has a scriber blade and performs mechanical scribing may be cited. In this case, it is preferable that the material of the scriber blade is diamond.

When the scribing means is a means that has a scriber blade and performs mechanical scribing, it is preferable that an angle α formed between a face of the scriber blade on the side that moves relative to the flexible substrate and a normal line to the surface of the flexible substrate is −80°≦α≦35°, and more preferably −70°≦α≦0°. The angle α describe above is referred to herein as “rake angle”.

FIG. 8B is a sectional view schematically illustrating a flexible substrate B, a target scribing film M, a scriber blade 31, and a rake angle α. When face S1 of scriber blade 31 on the side that moves relative to the flexible substrate is inclined to a side opposite to the relative moving direction D with respect to the normal line V to the surface of the flexible substrate, it is defined herein that α>0, and when face S1 is inclined to the same direction as the relative moving direction D with respect to the normal line V to the surface of the flexible substrate, it is defined that α<0. In FIG. 8B, an example position of scriber blade 31 when α>0 is represented by the solid line and an example position of scriber blade 31 when α<0 is represented by the broken line.

The scribing means may be a means that has a laser light emission optical system and performs laser scribing.

Preferably, the scribing apparatus of the present invention is an apparatus, including a plurality of sets of the pressing means and scribing means to increase the depth and/or width of a separation groove to be formed in the target scribing film in a stepwise manner.

The scribing apparatus of the present invention is preferably applied to a case where the flexible substrate is a substrate of a metal base on which an insulation film is formed and the target scribing film is a semiconductor film, a conductive film, or a laminated film of these films, or the like. The scribing apparatus of the present invention is preferably applied to the manufacture of a photoelectric conversion device. The scribing apparatus of the present invention is preferably applied to the manufacture of a photoelectric conversion device having a photoelectric conversion layer that includes a compound semiconductor formed of a group Ib element, a group IIIb element, and a group VIb element. The scribing apparatus of the present invention is preferably applied to the manufacture of a photoelectric conversion device having a photoelectric conversion layer that includes a compound semiconductor formed of at least one type of group Ib element selected from the group consisting of Cu and Ag, at least one type of IIIb element selected from the group consisting of Al, Ga, and In, and at least one type of VIb element selected from the group consisting of S, Se, and Te.

Element group representation herein is based on the short period periodic table. A compound semiconductor formed of a group Ib element, a group IIIb element, and a group VIb element is sometimes represented herein as “group I-III-VI semiconductor”. Each of the group Ib element, group IIIb element, and group VIb element, which are constituent elements of group I-III-VI semiconductor, may be one type or two or more types of elements. Further, the I-III-VI semiconductor included in the photoelectric conversion layer may be one type or two or more types of semiconductors.

A scribing method of the present invention is a method for performing scribing, while conveying a web of strip-like continuous flexible substrate on which a target scribing film is formed by applying a tensile strength to the flexible substrate, on the target scribing film with the flexible substrate being pressed by a convex curved surface by bringing the convex curved surface into contact with the flexible substrate from a side on which the target subscribing film is not formed,

wherein a tensile strength Tn and a pressing force P applied to the flexible substrate per unit cross-sectional area during the scribing satisfy Formulae (1) to (3) below:

1.5 MPa≦Tn≦25 MPa (1)

4 kPa≦P≦50 kPa (2)

5 GPa²≦Tn×P≦800 GPa² (3)

The tensile strength Tn and pressing force P are parameters represented by the following formulae:

Tn=T/S_{S}(Pa),P=T/(W×R)(Pa)

(where, T represents the tensile strength applied the entire cross-section of the flexible substrate, S_{S} represents the cross-sectional area of the flexible substrate, W represents the width of the flexible substrate, and R represents the radius of curvature of the convex curved surface.)

According to the scribing apparatus and scribing method of the present invention, while conveying a substrate web, scribing may be performed efficiently and highly accurately on a target scribing film with a high yield rate and stably.

### BRIEF DESCRIPTION OF DRAWINGS

FIG. 1 is a perspective view of a scribing apparatus according to an embodiment of the present invention.

FIG. 2 is a design modification of the apparatus shown in FIG. 1.

FIG. 3 is a design modification of the apparatus shown in FIG. 1.

FIG. 4 is a design modification of the apparatus shown in FIG. 1.

FIG. 5A is a schematic sectional view of a photoelectric conversion device taken along a lateral direction, illustrating an example structure thereof.

FIG. 5B is a schematic sectional view of a photoelectric conversion device taken along a longitudinal direction, illustrating an example structure thereof.

FIG. 6 is a schematic sectional view of a substrate, illustrating the structure thereof.

FIG. 7 is a perspective view of a substrate, illustrating a manufacturing method thereof.

FIG. 8A is a front elevation of a scriber blade and an adjacent portion viewed from a traveling direction of the scriber blade.

FIG. 8B is a sectional view schematically illustrating a flexible substrate, a target scribing film, a scriber blade, and a rake angle.

### BEST MODE FOR CARRYING OUT THE INVENTION

### Scribing Apparatus

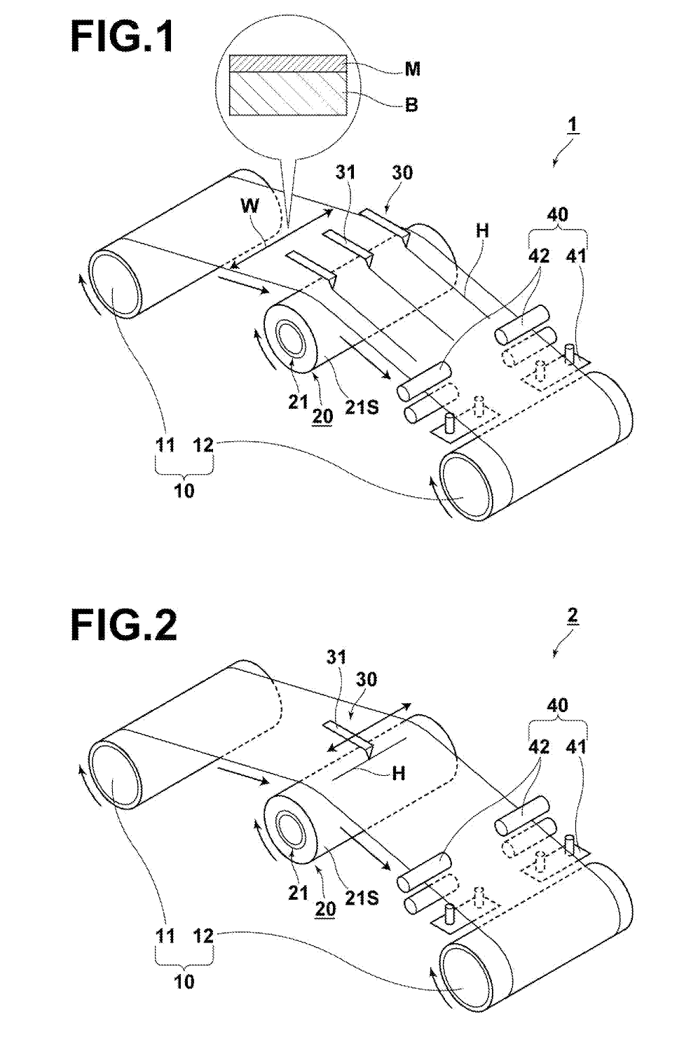

A structure of a scribing apparatus according to an embodiment of the present invention will be described with reference to the accompanying drawings. FIG. 1 is a schematic perspective view of the apparatus.

Scribing apparatus 1 of the present embodiment includes conveyance means 10 for conveying a web of strip-like continuous flexible substrate B on which a target scribing film M is formed by applying a tensile strength to the flexible substrate, pressing means 20 for pressing the flexible substrate B from a side on which the target scribing film M is not formed, and scribing means 30 for performing scribing on the target scribing film M formed on the surface of a portion of the flexible substrate B pressed by pressing means 20.

There is not any specific restriction on the flexible substrate B, and a metal substrate, a substrate of metal base with an insulation film formed thereon, a resin substrate, and the like are cited. There is not any specific restriction on the target scribing film M, and a semiconductor film, a conductive film, a laminated film of these films, and the like are cited.

In the present embodiment, conveyance means 10 is roughly constituted by first turnable roller (payout roller) 11 for paying out the strip-like continuous flexible film B on which the target scribing film M is formed and second turnable roller (roll-up roller) 12 for rolling up the flexible substrate B after subjected to the scribing. First roller 11 may be a conveyance roller that conveys the substrate from a previous process to the scribing process. Likewise, second roller 12 may be a conveyance roller that conveys the substrate from the scribing process to a next process.

Pressing means 20 is roughly constituted by turnable pressing roller 21 for pressing flexible substrate B and a position adjustment mechanism (not shown) for adjusting the position of the roller 21 in up-down directions. Pressing roller 21 has convex curved surface 21S which is brought into contact with the flexible substrate B from the side on which the target scribing film M is not formed to press the flexible substrate B. Pressing roller 21 has a positioning function for the scribing as well as the function for pressing flexible substrate B.

In the present embodiment, the position of pressing roller 21 in up-down direction is adjustable by the position adjustment mechanism, and the pressing force and tensile strength applied to the flexible substrate B by pressing roller 21 may be adjusted by adjusting the position of pressing roller 21 (convex curved surface 21S).

There is not any specific restriction on width W of flexible substrate B and, for example, 150 to 2000 mm. There is not any specific restriction on the width of first roller 11, second roller 12, and pressing roller 21, and a width of 1.2 to 1.5 times the width W of flexible substrate B is preferable. There is not any specific restriction on the radius of pressing roller 21, and 40 to 300 mm is preferable. There is not any specific restriction on the conveyance speed of the substrate and is, for example, 1 to 150 m/min.

Scribing means 30 is disposed opposite to pressing roller 21 across the flexible substrate B and is roughly constituted by a plurality of scriber blades 31 for mechanically performing scribing. The plurality of scriber blades 31 is arranged in the width direction of flexible substrate B. The position of each scriber blade 31 in the width direction of the substrate and up-down direction is adjustable. In FIG. 1, the reference symbol H represents a separation groove formed by the scribing.

Apparatus 1 of the present embodiment also includes meandering correction means 40, each constituted by meandering detection sensor 41 and a plurality of meandering correction rollers 42.

In the present embodiment, the position of each scriber blade 31 in the width direction of the substrate and the clearance between each scriber blade 31 and pressing roller 21 are set to specific values according to the scribing section of the target scribing film M and the depth of the separation groove H to be formed, and while a tensile strength and a pressing force are applied to the flexible substrate B, a specific load is applied to scriber blade 31 to perform scribing such that the surface of the target scribing film M is scratched.

In the present embodiment, the position of scriber blade 31 is adjusted during an off-time of scribing and basically fixed during scribing. It is preferably, however, that fine movement control is performed on scriber blade 31 such that the clearance between scriber blade 31 and pressing roller 21 is maintained constant following a vibration of the apparatus and the like. Implementation of such control allows separation grooves H with small variations in the depth and width to be formed.

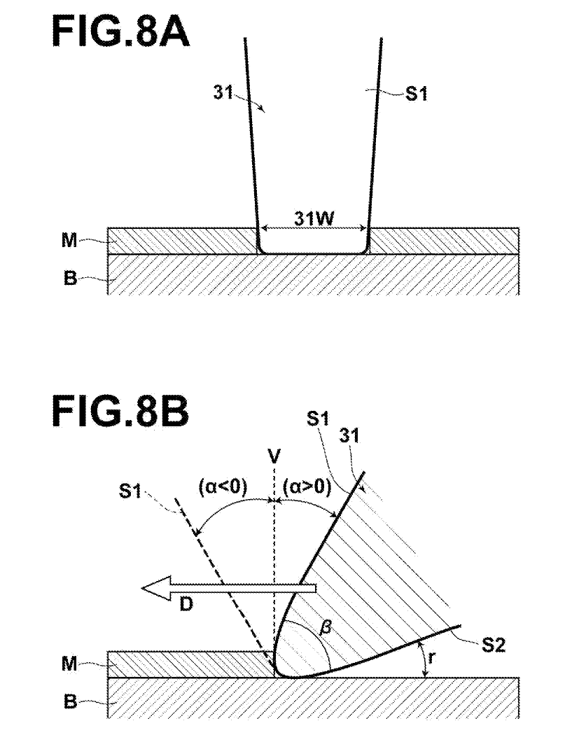

There is not any specific restriction on the width 31W of the cutting edge of scriber blade and is selected according to the width of a separation groove H. The width 31W of the cutting edge refers to a maximum width contacting the target scribing film M in a front elevation of the scriber blade 31 viewed from a traveling direction thereof (FIG. 8A, which is a front elevation of a scriber blade and an adjacent portion viewed from a traveling direction of the scriber blade). The width 31W of the cutting edge of scriber blade 31 is selected, for example, from the range of 10 to 300 μm. There is not any specific restriction on the load applied to scriber blade 31 and selected, for example, from the range of 150 to 400 mN.

In order to stably forming separation grooves H in the target scribing film M by preventing warpage, undulation, and deflection of the flexible substrate B, the tensile strength and pressing force applied to the flexible substrate B are important. Apparatus 1 of the present embodiment is adjusted such that the tensile strength Tn and pressing force P applied to the flexible substrate B per unit cross-sectional area at the time of scribing satisfy Formulae (1) to (3) below.

1.5 MPa≦Tn≦25 MPa (1)

4 kPa≦P≦50 kPa (2)

5 GPa²≦Tn×P≦800 GPa² (3)

Tensile strength Tn and pressing force P are parameters represented by the following formulae.

Tn=T/S_{S}(Pa),P=T/(W×R)(Pa)

(where, T represents the tensile strength applied to the entire cross-section of the flexible substrate, S_{S} represents the cross-sectional area of the flexible substrate, W represents the width of the flexible substrate, and R represents the radius of curvature of the convex curved surface.)

As described above, in the present embodiment, the position of the pressing roller 21 in up-down directions is adjustable and the pressing force and tensile strength applied to the flexible substrate B by pressing roller 21 is adjustable. In the present embodiment, the position of pressing roller is adjusted such that Formulae (1) to (3) above are satisfied and the adjusted position is maintained during scribing.

There is not any specific limitation on the material of scriber blade 31, and a hard material resistant to breakage and abrasion is preferably used. Such materials include diamond, boron nitride, various types of metals, and the like. Among them, diamond is most preferably used since it is durable and allows scribing of stable size and shape.

There is not any specific restriction on the angle (rake angle) α formed between face S1 of scriber blade 31 on the side that moves relative to the flexible substrate B and a normal line to the surface of the flexible substrate (for α and plus/minus thereof, reference is directed to the description under “Disclosure of Invention” and FIG. 8B). The inventor of the present invention has confirmed that favorable scribing may be performed with a rake angle α at least in the range −80°≦α≦35° (Examples 15 to 22).

As illustrated in FIG. 8B, if α>0, face S1 of scriber blade 31 on the side that moves relative to the flexible substrate B is inclined opposite to the relative moving direction D with respect to the normal line V to the surface of the flexible substrate. In this case, scriber blade 31 takes the form of breaking into between the flexible substrate B and an uncut portion of the target scribing film M to be cut now.

On the other hand, if α<0, face S1 of scriber blade 31 on the side that moves relative to the flexible substrate B is inclined to the relative moving direction D with respect to the normal line V to the surface of the flexible substrate. In this case, scriber blade 31 takes the form of overhanging on an uncut portion of the target scribing film M to be cut now.

The inventor of the present invention has found that a so-called picking in which an uncut portion to be cut now is detached irregularly over an excessive range occurs frequently when α>0 and less frequently when α<0. When the picking occurs, accurate scribing is prevented and the yield rate is decreased. Thus, α≦0 is preferable and α<0 is more preferable. Further, when α<−70°, scriber blade 31 is excessively inclined to a horizontal side which may prevent accurate scribing in the depth direction. Preferably, the rake angle α is −70°≦α≦0, more preferably, −70°≦α≦−5°, and particularly preferable, −60°≦α≦−35°.

There is not any specific restriction on the angle (clearance angle) γ formed between face S2 of scriber blade 31 opposite to the side that moves relative to the flexible substrate B and the surface of the flexible substrate B, and is preferable to be not smaller than 10°. When γ is in the range described above, scribing of stable quality may be performed.

Scribing apparatus 1 of the present embodiment is structured in the manner as described above. In the present embodiment, the tensile strength and pressing force applied to the flexible substrate B at the time of scribing are adjusted in preferable ranges, so that the warpage, undulation, deflection, and the like are favorably reduced. This allows easy control of positioning, cutting depth, and the like of scribing, whereby accurate scribing may be performed. Further, it is not likely that excessive tensile strength or pressing force is applied to the flexible substrate B which may cause small abrasions and cracks around a separation groove H formed or invisible damages.

Thus, according to scribing apparatus 1 of the present embodiment and a scribing method using the same, efficient and accurate scribing may be performed on the target scribing film M with a high yield rate and stably. The use of scribing apparatus 1 of the present embodiment allows separation grooved H to be formed highly accurately even under the conditions of roll-to-roll processing that requires a faster processing speed than that of a sheet-to-sheet processing.

Scribing apparatus 1 of the present embodiment may be used for manufacturing any electronic device that requires scribing. Scribing apparatus 1 of the present embodiment may be preferably used for manufacturing a photoelectric conversion device. Scribing apparatus 1 of the present embodiment may be preferably used for manufacturing a photoelectric conversion device having a photoelectric conversion layer that includes a compound semiconductor formed of a group Ib element, a group IIIb element, and a group VIb element. Scribing apparatus 1 of the present embodiment may be preferably used for manufacturing a photoelectric conversion device having a photoelectric conversion layer that includes a compound semiconductor formed of at least one type of group Ib element selected from the group consisting of Cu and Ag, at least one type of IIIb element selected from the group consisting of Al, Ga, and In, and at least one type of VIb element selected from the group consisting of S, Se, and Te.

When a photoelectric conversion device is manufactured using scribing apparatus 1 of the present embodiment, the photoelectric conversion rate of the device is improved. This would be the ability of the apparatus to perform highly accurate scribing and reduced stress incurred on the device during processing, whereby defects or damages are reduced.

(Design Changes)

The present invention is not limited to the embodiment described above, and design changes may be made as appropriate without departing from the sprit of the present invention.

The form of pressing means 20 is not limited to pressing roller 21, and any form may be employed as long as it has a convex curved surface.

As scribing apparatus 2 shown in FIG. 2, scriber blade 31 may be configured to be scannable in width directions of the substrate. Such structure allows scribing in a parallel direction, a vertical direction, and an oblique direction with respect to the conveyance direction of the substrate. For example, a vertical scribing may be performed by conveying the substrate intermittently and scanning scriber blade 31 in width directions of the substrate while the conveyance is stopped.

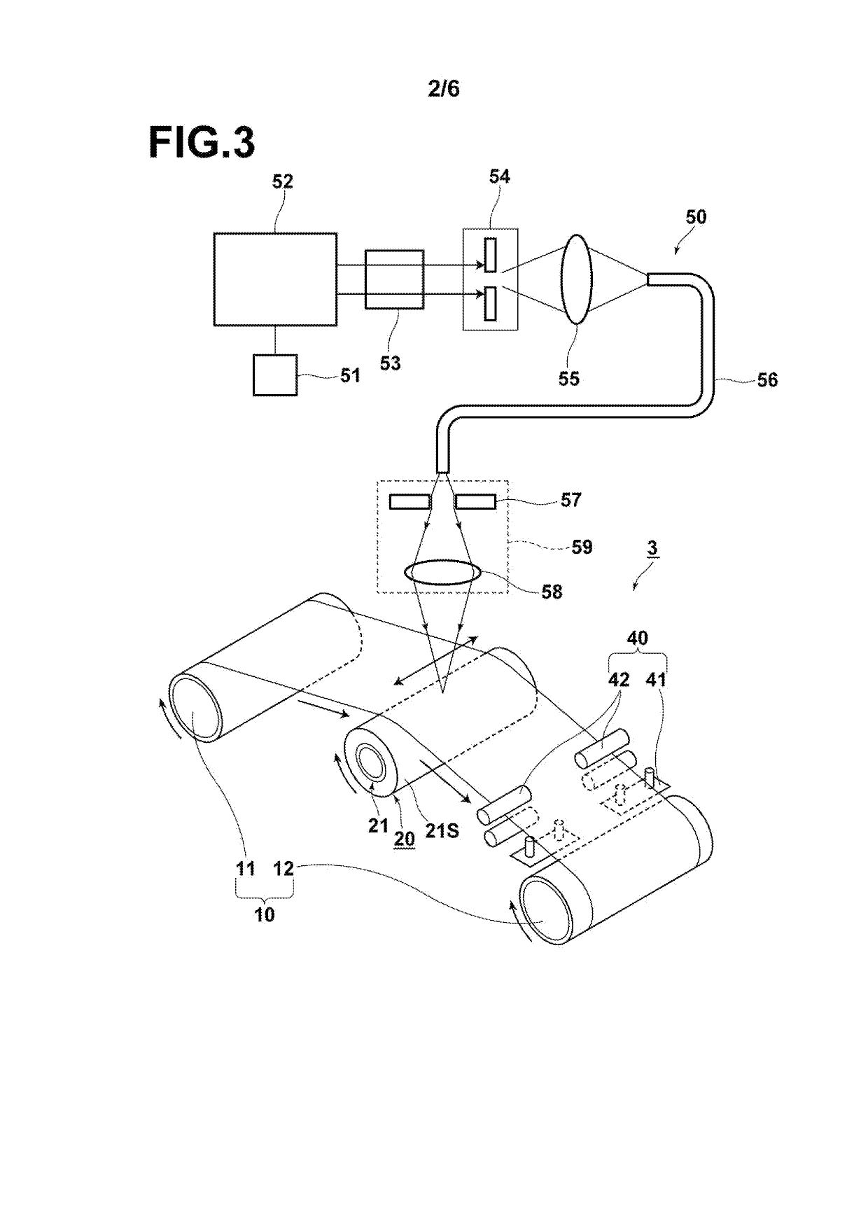

As scribing apparatus 3 shown in FIG. 3, the scribing means may be a means which is roughly constituted by laser light emission optical system 50 and performs laser scribing. Laser light emission optical system 50 includes laser oscillator 52 which is energized by power source 51 and oscillates laser light, light control/transmission optical systems 53 to 56 for controlling or transmitting the laser light, and laser head 59 for emitting the laser light on the surface of a target scribing film M formed on a flexible substrate B.

The light control/transmission optical systems include attenuator 53 for controlling the energy of the laser light oscillated in the laser oscillator 56, slit 54 for shaping the optical image of the laser light into a slit-like form, condenser lens 55 for condensing the laser light shaped into the slit-like form, and optical fiber 56 for transmitting the laser light condensed by condenser lens 55.

Laser head 59 includes variable slit 57 for reshaping the optical image of the laser light transmitted through optical fiber 56 into a slit-like form having a desired size and condenser lens 58. Laser head 59 is configured to be scannable in width directions of the substrate.

There is not any specific restriction on the wavelength of the laser light and appropriately designed according to the light absorption wavelength of a target scribing film M. For example, when the target scribing film M is a Mo lower electrode of a photoelectric conversion device, laser light with a center wavelength of 500 to 1100 nm is preferably used. If the target scribing film M is a photoelectric conversion layer or an upper electrode of a photoelectric conversion device, laser light with a center wavelength of not greater than 400 nm is preferably used. Laser emission conditions, such as the wavelength, emission energy, laser output pattern, emission time, and the like, are adjusted according to the light absorption coefficient of the target scribing film M, whereby accurate scribing with a desired depth and width may be performed. In a short wavelength range, the absorption coefficient is high and diffraction effect or the like is small, so that the laser emission range may be determined easily without unnecessary power being applied to a surrounding area, whereby the scribing may be performed accurately.

Optical systems of laser light emission optical system 50 are not limited to those shown in FIG. 3 and are appropriately changed in the designs.

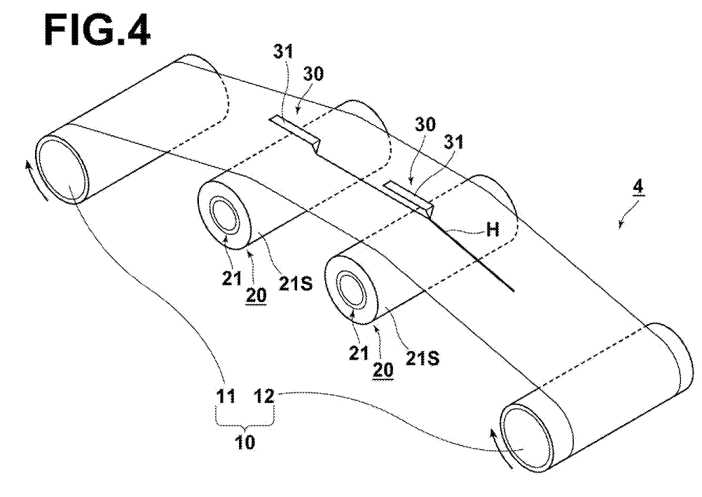

As scribing apparatus 4 shown in FIG. 4, a plurality of sets of pressing means 20 and scribing means 30 may be provided. Such structure allows the depth and/or width of a separation groove H to be increased in a stepwise manner. Such design change may also be applicable to the apparatus shown in FIG. 3.

The structure for increasing the depth and/or width of a separation groove H to be formed on a target scribing film M in a stepwise manner may reduce an instantaneous load (a mechanical load in mechanical scribing and a thermal load in laser scribing) incurred by a surrounding area of a separation groove H at the time of scribing, whereby the yield rate and device performance may be improved. Further, the load (a mechanical load in mechanical scribing and a thermal load in laser scribing) incurred by pressing roller 21 may also be reduced, whereby the durability of the apparatus may be increased.

[Photoelectric Conversion Device]

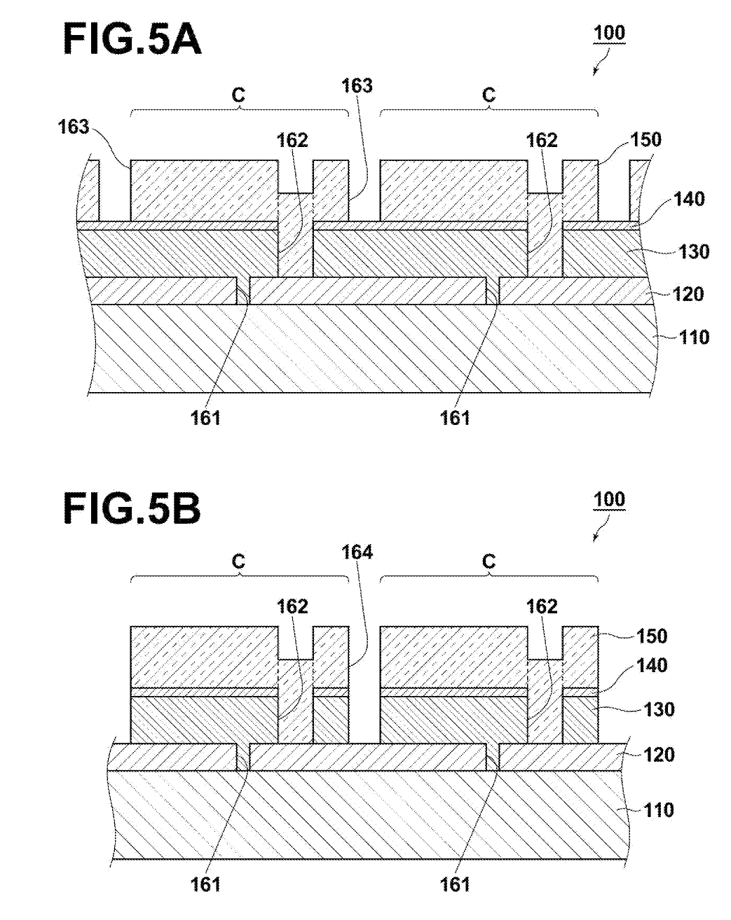

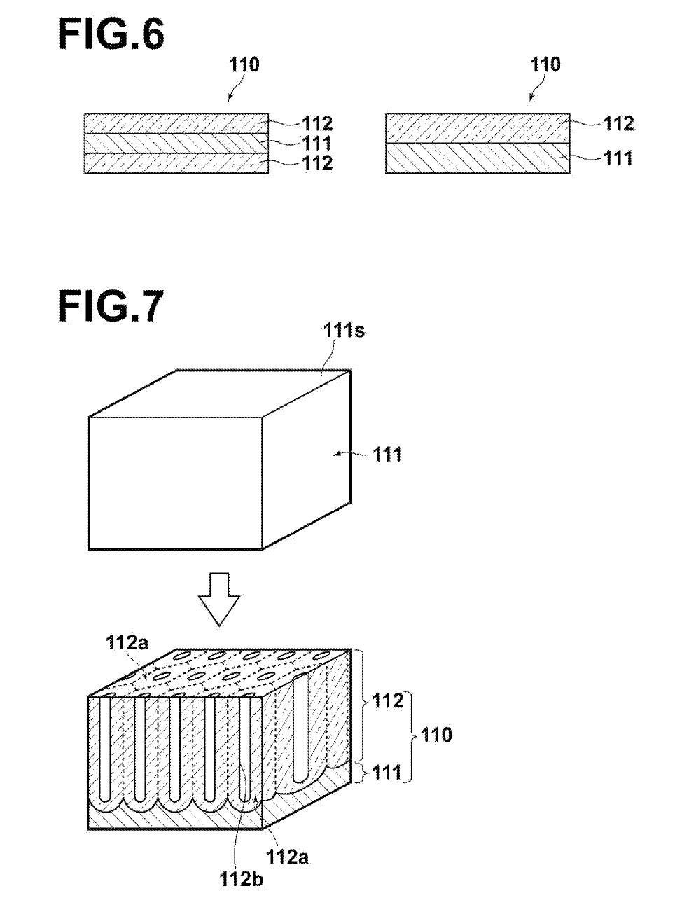

An example structure of a photoelectric conversion device which can be manufactured by a scribing apparatus of the present invention will be described with reference to the accompanying drawings. FIG. 5A is a schematic sectional view of the photoelectric conversion device in a lateral direction, and FIG. 5B is a schematic sectional view of the photoelectric conversion device in a longitudinal direction. FIG. 6 is a schematic sectional view of a substrate, illustrating the structure thereof, and FIG. 7 is a perspective view of a substrate, illustrating a manufacturing method thereof. In the drawings, each component is not drawn to scale in order to facilitate visual recognition. Generally, “lateral direction of a photoelectric conversion device” and “longitudinal direction of a photoelectric conversion device” correspond respectively to a width direction and a conveyance direction of a flexible substrate used.

As illustrated in FIGS. 5A and 5B, photoelectric conversion device 100 is a device having flexible substrate 110 on which lower electrode (rear electrode) 120, photoelectric conversion layer 130, buffer layer 140, and upper electrode layer 150 are stacked in this order.

Photoelectric conversion device 100 has first separation grooves 161 that run through only lower electrode 120, second separation grooves 162 that run through photoelectric conversion layer 130 and buffer layer 140, and third separation grooves 163 that run through only upper electrode layer 150 in a lateral sectional view and fourth separation grooves 164 that run through photoelectric conversion layer 130, buffer layer 140, and upper electrode layer 150 in a longitudinal sectional view.

The above configuration may provide a structure in which the device is divided into many cells C by first to fourth separation grooves 161 to 164. Further, upper electrode 150 is filled in second separation grooves 162, whereby a structure in which upper electrode 150 of a certain cell C is serially connected to lower electrode 120 of adjacent cell C may be obtained. Such configuration allows manufacture of an integrated device in which multiple unit devices are connected in series by a very simple process flow of repeating thin film formation and separation groove formation.

(Flexible Substrate)

In the present embodiment, flexible substrate 110 is a substrate obtained by anodizing at least one surface side of an Al-based metal base 111. Substrate 110 may be a substrate of metal base 111 having anodized film 112 on each side as illustrated on the left of FIG. 6 or a substrate of metal base 111 having anodized film 112 on either one of the sides as illustrated on the right of FIG. 6. Here, anodized film 112 is an Al₂O₃ based film. There is not any specific restriction on the thickness of metal base 111 and anodized film 112. The thickness of metal base 111 is, for example, 50 to 500 μm, and the thickness of anodized film 112 is, for example, 0.5 to 20 μm.

“Major component of the metal base” herein is defined as a component occupying 50% by mass or more. Metal base 111 may be a metal base that includes a minor element, a pure Al substrate, or an alloy of Al with another metal element. As metal base 111 on which anodized film 112 is formed, a pure Al substrate with an Al content of not less than 95% by mass is preferably used.

Anodization may be performed by immersing metal base 111, which is cleaned, smoothed by polishing, and the like as required, as an anode with a cathode in an electrolyte, and applying a voltage between the anode and cathode. As shown in FIG. 7, when Al based metal base 111 is anodized, an oxidization reaction proceeds from surface 111s in a direction substantially perpendicular to surface 111s, and Al₂O₃ based anodized film 112 is formed. Anodized film 112 generated by the anodization has a structure in which multiple fine columnar bodies, each having a substantially regular hexagonal shape in plan view, are tightly arranged. Each fine columnar body 112a has a fine pore 112b, in substantially the center, extending substantially linearly in a depth direction from surface 111s, and the bottom surface of each fine columnar body 112a has a rounded shape. Normally, a barrier layer without any fine pore 112b is formed at a bottom area of fine columnar bodies 112a. Anodized film 112 without any fine pore 112b may also be formed by appropriately arranging the anodizing conditions.

(Photoelectric Conversion Layer)

Photoelectric conversion layer 130 includes one or more types of compound semiconductors of at least one type of group Ib element, at least one type of group IIIb element, and at least one type of group VIb element (group I-III-VI semiconductors) and generates a current by absorbing light.

Preferably, photoelectric conversion layer 130 is a layer that includes one or more types of compound semiconductors of at least one type of group Ib element selected from the group consisting of Cu and Ag, at least one type of group IIIb element selected from the group consisting of B, Al, Ga, and In, and at least one type of group VIb element selected from the group consisting of O, S, Se, and Te.

In view of a high light absorption rate and high photoelectric conversion efficiency, it is preferable that photoelectric conversion layer 130 includes one or more types of compound semiconductors of at least one type of group Ib element selected from the group consisting of Cu and Ag, at least one type of group IIIb element selected from the group consisting of Al, Ga, and In, and at least one type of group VIb element selected from the group consisting of S, Se, and Te.

The compound semiconductors described above may include but not limited to CuAlS₂, CuGaS₂, CuInS₂, CuAlSe₂, CuGaSe₂, CuInSe₂ (CIS), AgAlS₂, AgGaS₂, AgInS₂, AgAlSe₂, AgGaSe₂, AgInSe₂, AgAlTe₂, AgGaTe₂, AgInTe₂, Cu (In₁₋ₓGaₓ)Se₂ (CIGS), Cu(In₁₋ₓAlₓ)Se₂, Cu(In₁₋ₓGaₓ)(S, Se)₂, Ag(In₁₋ₓGaₓ)Se₂, and Ag(In₁₋ₓGaₓ)(S, Se)₂.

It is particularly preferable that photoelectric conversion layer 130 includes CuInSe₂ (CIS) and/or CuInSe₂ solidified with Ga, i.e., Cu(In, Ga)Se₂ (CIGS). CIS and CIGS are semiconductors having a chalcopyrite crystal structure, and high light absorption rates and high energy conversion efficiency are reported. They also have excellent durability and have less deterioration in the efficiency due to light exposure.

Photoelectric conversion layer 130 includes an impurity for obtaining an intended semiconductor conductivity type. The impurity may be included in photoelectric conversion layer 130 by diffusing from an adjacent layer or by active doping.

Photoelectric conversion layer 130 may have a density distribution of constituent elements of group I-III-VI semiconductors and/or impurities, and may have a plurality of layer regions of different semiconductivities, such as n-type, p-type, i-type, and the like. For example, in the CIGS system, the band gap width/carrier mobility and the like may be controlled by providing a distribution of the amount of Ga in photoelectric conversion layer 130 in the thickness direction, whereby high conversion efficiency may be designed.

Photoelectric conversion layer 130 may include one or more types of semiconductors other than the group I-III-VI semiconductor. Semiconductors other than the group I-III-VI semiconductor may include but not limited to a semiconductor of group IVb element, such as Si (group IV semiconductor), a semiconductor of group IIIb element and group Vb element such as GaAs (group III-V semiconductor), and a semiconductor of group IIb element and group VIb element, such as CdTe (group II-VI semiconductor).

Photoelectric conversion layer 130 may include any arbitrary component other than semiconductors and an impurity for causing the semiconductors to become an intended conductivity type within a limit that does not affect the properties. There is not any specific restriction on the content of group I-III-VI semiconductors in photoelectric conversion layer 130, in which not less than 75% by mass is preferable, not less than 95% by mass is more preferable, and not less than 99% by mass is particularly preferable.

(Electrodes, Buffer Layer)

Each of lower electrode 120 and upper electrode 150 is made of a conductive material. Upper electrode 50 on the light input side needs to be transparent. In view of effective use of light, it is preferable that lower electrode 120 on the substrate side has light reflectivity. When a main layer of photoelectrical conversion layer 130 excluding a region adjacent to buffer layer 140 is a p-type semiconductor, lower electrode 120 is used as a positive electrode and upper electrode 150 is used as a negative electrode. If the main layer of photoelectric conversion layer 130 is an n-type semiconductor, the polarity of lower electrode 120 and upper electrode 150 is reversed.

As for the major component of lower electrode 120, Mo, Cr, W, or a combination thereof is preferably used. As for the major component of upper electrode 150, ZnO, ITO (indium tin oxide) SnO₂, or a combination thereof is preferably used. Lower electrode 120 and/or upper electrode 150 may have a single layer structure or a laminated structure, such as a two-layer structure. As for buffer layer 140, CdS, ZnS, ZnO, ZnMgO, ZnS (O, OH), or a combination thereof is preferably used. The major component of the electrodes and buffer layer is defined as a component occupying 50% by mass or more. A preferable combination of the compositions is, for example, Mo lower electrode/CdS buffer layer/CIGS photoelectric conversion layer/ZnO upper electrode.

(Other Layers)

Photoelectric conversion device 100 may have any other layer as required in addition to those described above. For example, a contact layer (buffer layer) for enhancing the adhesion of layers may be provided, as required, between substrate 110 and lower electrode 120, and/or between lower electrode 120 and photoelectric conversion layer 130. Further, an alkali barrier layer for preventing diffusion of alkali ions may be provided, as required, between substrate 110 and lower electrode 120. A reference is directed to Japanese Unexamined Patent Publication No. 8 (1996)-222750 for a preferred embodiment of the alkali barrier layer.

Photoelectric conversion device 100 of the present embodiment is structured in the manner as described above. In the manufacture of photoelectric conversion device 100, scribing is performed to form first to fourth separation grooves 161 to 164. For the photoelectric conversion device 100, scribing appropriate for the material and property of each film is performed. For a CIGS device, for example, first separation grooves 161 are formed by laser scribing while second to fourth separation grooves 162 to 164 are formed by mechanical scribing using a scriber blade or laser scribing.

By forming separation grooves 161 to 164 using the scribing apparatus of the present invention, photoelectric conversion devices 100 having high photoelectric conversion efficiency may be manufactured with a high yield rate and stably, while conveying a substrate web. The use of the scribing apparatus of the present invention allows separation grooves 161 to 164 to be formed highly accurately even under the conditions of roll-to-roll processing that requires a faster processing speed than that of a sheet-to-sheet processing.

Photoelectric conversion device 100 shown here is just an example, and the scribing apparatus of the present invention is applicable to the manufacture of any type of photoelectric conversion device using a flexible substrate, such as metal substrate, substrate of metal base on which an insulation film is formed, resin substrate, or the like. Further, the scribing apparatus of the present invention is applicable to the manufacture of any other device than photoelectric conversion device.

### EXAMPLES

Examples and Comparative Examples will now be described.

### Example 1

### Manufacture of Photoelectric Conversion Layer Substrate

A strip-like continuous Al thin plate with a purity of not less than 99.5% and a width of 300 mm was provided as the metal base. After polishing the surface, the Al plate was anodized in a boric acid solution to obtain a strip-like continuous flexible substrate of a 200 μm thick Al base having a 5 μm thick anodized film (Al₂O₃ film) on each side. The anodized film is has fine pores formed in a regular manner in which the thickness of the barrier layer was about 50 nm, the pitch of fine pores was about 150 nm, and the pore diameter of the fine pores was about 50 nm.

### <Manufacture of Photoelectric Conversion Device and Solar Cell Module>

A Mo lower electrode with a thickness of 0.7 μm was formed over the entire surface of the obtained photoelectric conversion layer substrate by Ar sputtering. Thereafter, laser scribing was performed on the Mo lower electrode using the apparatus shown in FIG. 3 to form a plurality of first separation grooves with a depth of about 0.7 μm and a width of about 130 μm. The conveyance speed of the substrate was 3 m/min. As for the laser, YAG laser with a center wavelength of 1064 nm was used. Viewed in a width direction of the substrate, a plurality of first separation groove was formed with a pitch of 10 mm, whereby the lower electrode was divided into 24 cells.

Then, as a photoelectric conversion layer, a Cu (In_{0.7}Ga_{0.3}) Se₂ thin film was deposited by multi source simultaneous deposition with a thickness of about 1.7 μm over the entire surface of the substrate having the lower electrode formed thereon. The deposition of the Cu (In_{0.7}Ga_{0.3}) Se₂ thin film was performed under a vacuum degree of about 10⁻⁴ Pa (10⁻⁷ Torr) by providing Cu, In, Ga, and Se deposition sources in a vacuum vessel. Here, the temperature of the deposition crucible was controlled appropriately and substrate temperature was 530° C.

Next, as a buffer layer, a CdS film was deposited by chemical deposition with a thickness of about 50 nm over the entire surface of the substrate having the photoelectric conversion layer formed thereon. The chemical deposition was performed by heating a water solution of cadmium nitrate, thiourea, and ammonia to about 80° C. and soaking the photoelectric conversion layer in the water solution.

After forming the buffer layer, mechanical scribing was performed on the photoelectric conversion layer and buffer layer using the apparatus shown in FIG. 1 to form a plurality of second separation grooves with a depth of about 1.8 μm and a width of about 140 μm. The plurality of second separation grooves was formed simultaneously by arranging scriber blades corresponding to the number of second separation grooves to be formed. The conveyance speed of the substrate was 18 m/min. A flat diamond scriber blade with a cutting edge width of 100 μm was used. Viewed in a width direction of the substrate, a plurality of second separation grooves was formed with a pitch of 10 mm, whereby the stack of photoelectric conversion layer and buffer layer was divided into 24 cells. Conditions for brining the scriber blade into contact with the substrate were as follows.

Rake angle α=−35°

Cutting edge angle β=60°

Clearance angle γ=65°

Load applied to scriber blade=280 mN

Next, as an upper electrode, Al doped ZnO film was formed by Ar sputtering with a thickness of 0.6 μm. After forming the upper electrode, mechanical scribing using a scriber blade was performed on the upper electrode using the same apparatus as that used for forming the second separation grooves to form a plurality of third separation grooves with a depth of about 3.2 μm and a width of about 140 μm, whereby the upper electrode was divided into 24 cells. Viewed in a width direction of the substrate, a plurality of second separation grooves was formed with a pitch of 10 mm, whereby the upper electrode was divided into 24 cells. The scribing blade used and conditions for brining the scriber blade into contact with the substrate were identical to those for forming the second separation grooves.

Then, mechanical scribing using a scriber blade was performed on the photoelectric conversion layer, buffer layer and upper electrode using the apparatus shown in FIG. 2 to form a plurality of fourth separation grooves with a depth of about 3.2 μm and a width of about 200 μm. The substrate was conveyed by intermittent conveyance and each of the fourth separation grooves was formed by scanning the scriber blade in a width direction of the substrate while the conveyance was stopped. A flat diamond scriber blade with a cutting edge width of 160 μm was used. The angle and loading conditions when the scriber blade was brought into contact with the substrate were identical to those for forming the second separation grooves. Formation of the plurality of fourth separation grooves results in the stack of the photoelectric conversion layer, buffer layer, and upper electrode to be divided into cell units of 24 cells arranged in a width direction of the substrate.

Thereafter, the substrate was cut into a plurality of 240 mm square devices and Pd was deposited to form drawing-out external electrodes, whereby photoelectric conversion devices were obtained. Finally, a transparent resin for sealing was laminated, whereby a solar cell module was obtained. A total of 20 solar cell modules were produced under the same condition. Each module has a structure in which three cell units, each having 24 cells connected in series, are connected in parallel.

The first to fourth separation grooves were formed under the same conditions with respect to the radius of the pressing roller, tensile strength Tn and pressing force P, Tn×P, applied to the flexible substrate per unit cross-sectional area at the time of scribing. These data are shown in Table 1.

### <Photoelectric Conversion Efficiency and Yield Rate Evaluations>

Photoelectric conversion efficiency was evaluated for each produced solar cell module using pseudo sunlight of Air Mass (AM)=1.5, 100 mW/cm². Photoelectric conversion efficiency was measured for 20 samples, and those having photoelectric conversion efficiency of 80% or more of a maximum value among them were evaluated as acceptable products and those other than the acceptable products were evaluated as unacceptable products. Then, an average value of photoelectric conversion efficiency of the acceptable products was obtained as the photoelectric conversion efficiency. Further, the yield rate was obtained by the formula below.

Yield Rate=number of acceptable products/total number of evaluated samples(%).

### Examples 2 to 11

### Comparative Examples 1 to 3

Solar cell modules were obtained and evaluated in a similar manner to that of Example 1 other than that the conditions with respect to the radius of the pressing roller, tensile strength Tn and pressing force P, Tn×P, applied to the flexible substrate per unit cross-sectional area at the time of scribing were changed to those shown in Table 1.

(Results)

As shown in Table 1, Examples 1 to 11 produced by setting conditions with respect to the radius of the pressing roller, tensile strength Tn and pressing force P, Tn×P, applied to the flexible substrate per unit cross-sectional area at the time of scribing within the ranges of the present invention has higher photoelectric conversion efficiency and yield rate in comparison with Comparative Examples 1 to 3 produced by setting the parameters outside of the ranges of the present invention, meaning that photoelectric conversion devices having excellent properties were produced stably.

For Examples 1 to 11, the radius of the pressing roller was set within the range from 40 to 300 mm, which provided favorable results. Note that the manufacture of a pressing roller with a radius greater than 300 mm was difficult and evaluation thereof was not conducted.

### Example 12

Solar cell modules were obtained and evaluated in the same manner as that for Example 5 other than that the second and third separation grooves were formed in two steps using the apparatus shown in FIG. 4. The clearance between the scriber blade and pressing roller of each of two pairs was adjusted such that the first scribing depth corresponds to 70% of a desired depth and the second scribing provides the desired depth. Manufacturing conditions and evaluation results of Examples 5 and 12 are shown in Table 2. As shown in Table 2, Example 12 in which scribing was performed in two steps for one separation groove has favorable results, that is, has higher photoelectric conversion efficiency and yield rate in comparison with Example 5 in which scribing was performed in single step for one separation groove. This shows that it is more preferable to perform scribing in a plurality of steps.

### Examples 13 and 14

Solar cell modules were obtained and evaluated in the same manner as that for Example 5 other than that the materials of scriber blade were changed to those shown below.

### Example 13

### Boron Nitride Sintered Body (BN)

### Example 14

### WC—TiC—TaC—Co Alloy (Equivalent to JIS-K-10 Material)

Manufacturing conditions and evaluation results of Examples 5, 13, and 14 are shown in Table 3. As Table 3 shows, diamond is particularly preferable as the material of the scriber blade.

### Examples 15 to 22

Solar cell modules were obtained and evaluated in the same manner as that for Example 5 other than that the conditions for brining the scriber blade into contact with the substrate were changed to those shown in Table 4. As shown in Table 4, Examples 15 to 22 produced by setting the rake angle α to −80 to 35° provided favorable results. More favorable results were obtained when the rake angle α was set to −70 to −5°, more preferably to −60 to −35°.

### Examples 23

Solar cell modules were obtained and evaluated in the same manner as that for Examples 1 to 11 other than that the second to fourth separation grooves were formed by laser scribing using the apparatus shown in FIG. 3. As for the laser, a third harmonic of YAG with a center wavelength of 355 nm was used. Each module showed identical results to those of Examples 1 to 11.

TABLE 1

| | P/Roller | | | | Yield | P/E Conv. |
|---|---|---|---|---|---|---|
| | Radius | Tn | P | Tn × P | Rate | Eff. |
| | (mm) | (MPa) | (kPa) | (GPa²) | (%) | (%) |
| EG 1 | 40 | 1.5 | 11.3 | 16.9 | 45.0 | 10.2 |
| EG 2 | 40 | 4.0 | 30.0 | 120.0 | 50.0 | 10.5 |
| EG 3 | 60 | 4.0 | 20.0 | 80.0 | 75.0 | 12.8 |
| EG 4 | 100 | 1.5 | 4.5 | 6.8 | 60.0 | 11.2 |
| EG 5 | 100 | 4.0 | 12.0 | 48.0 | 85.0 | 14.5 |
| EG 6 | 100 | 11.0 | 33.0 | 363.0 | 70.0 | 12.8 |
| EG 7 | 100 | 13.0 | 39.0 | 507.0 | 55.0 | 11.3 |
| EG 8 | 100 | 16.0 | 48.0 | 768.0 | 45.0 | 10.5 |
| EG 9 | 300 | 4.0 | 4.0 | 16.0 | 80.0 | 13.8 |
| EG 10 | 300 | 16.0 | 16.0 | 256.0 | 75.0 | 13.0 |
| EG 11 | 300 | 25.0 | 25.0 | 625.0 | 50.0 | 11.0 |
| C/E 1 | 100 | 1.0× | 3.0× | 3.0× | 25.0 | 7.7 |
| C/E 2 | 100 | 18.0 | 54.0× | 972.0× | 15.0 | 8.2 |
| E/E 3 | 300 | 30.0× | 30.0 | 900.0× | 25.0 | 8.9 |

TABLE 2

| | | | | | Yield | P/E Conv. |
|---|---|---|---|---|---|---|
| | | Tn | P | Tn × P | Rate | Eff. |
| | Scribing | (MPa) | (kPa) | (GPa²) | (%) | (%) |
| EG 5 | Single Step | 4.0 | 12.0 | 48.0 | 85.0 | 14.5 |
| EG 12 | Two Steps | 4.0 | 12.0 | 48.0 | 90.0 | 15.4 |

TABLE 3

| | | | | | Yield | P/E Conv. |
|---|---|---|---|---|---|---|
| | | Tn | P | Tn × P | Rate | Eff. |
| | Scriber Blade | (MPa) | (kPa) | (GPa²) | (%) | (%) |
| EG 5 | Diamond | 4.0 | 12.0 | 48.0 | 85.0 | 14.5 |
| EG 13 | BN | 4.0 | 12.0 | 48.0 | 75.0 | 12.5 |
| EG 14 | WC-TiC-TaC-Co | 4.0 | 12.0 | 48.0 | 65.0 | 11.3 |

TABLE 4

| | Rake | C/E | | Yield | P/E Conv. |
|---|---|---|---|---|---|
| | Angle | Angle | Clearance | Rate | Eff. |
| | α (°) | β (°) | γ (°) | (%) | (%) |
| EG 15 | 35 | 45 | 10 | 55.0 | 9.3 |
| EG 16 | 5 | 75 | 10 | 65.0 | 10.2 |
| EG 17 | −5 | 85 | 10 | 80.0 | 13.5 |
| EG 18 | −35 | 115 | 10 | 85.0 | 14.1 |
| EG 5 | −35 | 60 | 65 | 85.0 | 14.5 |
| EG 19 | −35 | 45 | 80 | 80.0 | 14.0 |
| EG 20 | −60 | 70 | 80 | 85.0 | 14.3 |
| EG 21 | −70 | 80 | 80 | 80.0 | 13.8 |
| EG 22 | −80 | 90 | 80 | 45.0 | 9.0 |

The scribing apparatus of the present invention may be used for scribing any target scribing film, and may be used for scribing a semiconductor film, a conductive film, a laminated film of these films, and the like of devices such as a photoelectric conversion device and the like.

1-15. (canceled)

16. A scribing apparatus, comprising:
a conveyance means for conveying a web of strip-like continuous flexible substrate on which a target scribing film is formed by applying a tensile strength to the flexible substrate;
a pressing means, having a convex curved surface, for pressing the flexible substrate by bringing the convex curved surface into contact with the flexible substrate from a side on which the target subscribing film is not formed; and
a scribing means for performing scribing on the target scribing film formed on the surface of a portion of the flexible substrate pressed by the pressing means,
wherein a tensile strength Tn and a pressing force P applied to the flexible substrate per unit cross-sectional area during the scribing satisfy Formulae (1) to (3) below:
1.5 MPa≦Tn≦25 MPa (1)
4 kPa≦P≦50 kPa (2)
5 GPa²≦Tn×P≦800 GPa² (3)
The tensile strength Tn and pressing force P are parameters represented by the following formulae:
Tn=T/S_{S}(Pa),P=T/(W×R)(Pa)
(where, T represents the tensile strength applied to the entire cross-section of the flexible substrate, S_{S} represents the cross-sectional area of the flexible substrate, W represents the width of the flexible substrate, and R represents the radius of curvature of the convex curved surface.)

17. The scribing apparatus of claim 16, wherein:
the conveyance means includes a first roller for paying out the flexible substrate and a second roller for rolling up the flexible substrate after subjected to the scribing; and
the pressing means includes a pressing roller for pressing the flexible substrate.

18. The scribing apparatus of claim 17, wherein the pressing roller has a radius of 40 to 300 mm.

19. The scribing apparatus of claim 16, wherein the position of the convex curved surface is changeable with respect to the flexible substrate.

20. The scribing apparatus of claim 16, wherein the scribing means is a means that has a scriber blade and performs mechanical scribing.

21. The scribing apparatus of claim 20, wherein the material of the scriber blade is diamond.

22. The scribing apparatus of claim 20, wherein an angle α formed between a face of the scriber blade on the side that moves relative to the flexible substrate and a normal line to the surface of the flexible substrate is −80°≦α≦35°.

23. The scribing apparatus of claim 20, wherein an angle α formed between a face of the scriber blade on the side that moves relative to the flexible substrate and a normal line to the surface of the flexible substrate is −70°≦α≦0°.

24. The scribing apparatus of claim 16, wherein the scribing means is a means that has a laser light emission optical system and performs laser scribing.

25. The scribing apparatus of claim 16, wherein the apparatus is an apparatus, comprising a plurality of sets of the pressing means and scribing means to increase the depth and/or width of a separation groove to be formed in the target scribing film in a stepwise manner.

26. The scribing apparatus of claim 16, wherein:
the flexible substrate is a substrate of a metal base on which an insulation film is formed; and
the target scribing film is a semiconductor film, a conductive film, or a laminated film of these films.

27. The scribing apparatus of claim 16, wherein the apparatus is an apparatus for manufacturing a photoelectric conversion device.

28. The scribing apparatus of claim 27, wherein the apparatus is an apparatus for manufacturing a photoelectric conversion device having a photoelectric conversion layer that includes a compound semiconductor formed of a group Ib element, a group IIIb element, and a group VI element.

29. The scribing apparatus of claim 28, wherein the apparatus is an apparatus for manufacturing a photoelectric conversion device having a photoelectric conversion layer that includes a compound semiconductor formed of at least one type of group Ib element selected from the group consisting of Cu and Ag, at least one type of group IIIb element selected from the group consisting of Al, Ga, and In, and at least one type of group VIb element selected from the group consisting of S, Se, and Te.

30. A scribing method for performing scribing, while conveying a web of strip-like continuous flexible substrate on which a target scribing film is formed by applying a tensile strength to the flexible substrate, on the target scribing film with the flexible substrate being pressed by a convex curved surface by bringing the convex curved surface into contact with the flexible substrate from a side on which the target subscribing film is not formed,
wherein a tensile strength Tn and a pressing force P applied to the flexible substrate per unit cross-sectional area during the scribing satisfy Formulae (1) to (3) below:
1.5 MPa≦Tn≦25 MPa (1)
4 kPa≦P≦50 kPa (2)
5 GPa²≦Tn×P≦800 GPa² (3)
The tensile strength Tn and pressing force P are parameters represented by the following formulae:
Tn=T/S_{S}(Pa),P=T/(W×R)(Pa)
(where, T represents the tensile strength applied to the entire cross-section of the flexible substrate, S_{S} represents the cross-sectional area of the flexible substrate, W represents the width of the flexible substrate, and R represents the radius of curvature of the convex curved surface.)
